(19) United States
(12) Patent Application Publication
(10) Pub. No.: US 2012/0210240 A1
(43) Pub. Date: Aug. 16, 2012

(54) USER INTERFACES FOR PERSONALIZED RECOMMENDATIONS

(75) Inventors: Eugene(John) Neystadt, Kfar-Saba (IL); Avigad Oron, Tel Aviv (IL); Ron Karidi, Herzeliya (IL); Roy Varshavsky, Even Yehuda (IL); Ron Dar Ziv, Tel Aviv (IL)

(73) Assignee: Microsoft Corporation, Redmond, WA (US)

(21) Appl. No.: 13/034,719

(22) Filed: Feb. 25, 2011

Related U.S. Application Data
(60) Provisional application No. 61/441,557, filed on Feb. 10, 2011.

(51) Int. Cl. G06F 3/048; G06F 17/30

(52) U.S. Cl. 715/739; 707/734; 707/E17.048

(57) ABSTRACT

A ranked set of users may be calculated from an expertise categorization for each user and a person's trust in the users for specific categories. The ranked set of users may be used for presenting search results, recommendations, social marketing, or other uses. A person's expertise may be determined through various online activities. A person's trust in another person may be related to their proximity and activity in one or more social networks.

### CROSS REFERENCE TO RELATED APPLICATIONS

This application claims the benefit of and priority to U.S. Provisional Patent Application Ser. No. 61/441,557 entitled “User Interfaces for Personalized Recommendations”, filed 10 Feb. 2011 by John Neystadt, et al., the entire contents of which are hereby incorporated by reference for all they teach and disclose.

### BACKGROUND

Everybody has a different set of values and different trust in various people. Their values may be expressed within their social networks by the types of people with whom they have relationships and the people that they trust.

### SUMMARY

User interface components may express information derived from a user's social network for various applications. The information may include products recommended by people who have trusted relationships with the user and the information may be tailored to the specific context in which the user interface is presented. A network architecture may include a remote service that searches one or more social network of a user and identifies persons who have expertise or interest in the specific context. The remote service may provide information that may be presented in the user interface, or may provide the user interface as a widget or other user interface component that may be integrated into a website or other application.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

In the drawings,

FIG. 1 is a diagram of an embodiment showing a network environment with a system for generating social network connected user interfaces.

FIG. 2 is a flowchart of an embodiment showing a method for analyzing a social network.

FIG. 3 is a flowchart of an embodiment showing a method for generating a user interface.

FIG. 4 is a diagram of an example embodiment showing a first user interface.

FIG. 5 is a diagram of an example embodiment showing a second user interface.

### DETAILED DESCRIPTION

User interface components may display information from formal and informal social networks in various applications. The user interface components may include information that is specific to a particular user, which may include information derived from the user's social network and inferences about the user's trust in various people within the user's social network.

The customized user interface components may reflect information for a specific usage context. Within each usage context, a user's social network may return a different set of results. A usage context may be a topic, item, category, or other classification of a host application for which the user interface components may be tailored.

Within a user's formal and informal social networks, each user may have a different level of trust for different people. This level of trust, combined with the different levels of expertise of people within the social network, may result in different results for each user.

The user interface components may be provided by a social marketing system and added to an application. In one embodiment, an application may include user interface objects that link to a social marketing system to display content from the social marketing system.

In some embodiments, the user interface may be a standalone component that may contain private information that may be personal to a user. In such embodiments, the user interface may protect information within the user interface from an application that may host the user interface component. In such embodiments, the user interface component may use some form of authentication to access personalized information. Such embodiments may use a single sign on mechanism or other authentication mechanism to connect to a server that provides the user interface component. Such embodiments may operate with the permission of a user.

Throughout this specification, the terms “user” and “person” or “people” are used in a specific manner. The term “user” relates to the person at the center of the social network. The user is the one for whom a ranked list may be generated, whereas the “people” are other people that may or may not be in the user's social network. The terms are used to help identify the user for whom any customization may be performed.

For the purposes of this specification and claims, the term “person” or “user” may refer to both natural people and other entities that operate as a “person”. A non-natural person may be a corporation, organization, enterprise, team, or other group of people.

For the purposes of this specification and claims, the term “social network” or “online social network” may relate to any type of computerized mechanism through which persons may connect or communicate with each other. Some social networks may be formal systems that facilitate end-to-end communications between people in a social network. Other social networks may be less formal, and may consist of a person's email contact list, phone list, mailing list, or other database from which a person may initiate or receive communication.

In some cases, a social network may facilitate one-way relationships. In such a social network, a first person may establish a relationship with a second person without having the second person's permission or even making the second person aware of the relationship. A simple example may be an informal email contact list where a person may store contact information for other people. Another example may be a social network where a first person “follows” a second person to receive content from the second person or where the person subscribes to a syndicated feed. The second person may or may not be made aware of the relationship.

In some cases, a social network may facilitate two-way relationships. In such a social network, a first person may request a relationship with a second person and the second person may approve or acknowledge the relationship so that the two-way relationship may be established. In some social networks, each relationship within the social network may be a two-way relationship. Some social networks may support both one-way and two-way relationships. Some social networks may also support one-to-many, many-to-many, and many-to-one relationships.

Throughout this specification, like reference numbers signify the same elements throughout the description of the figures.

When elements are referred to as being “connected” or “coupled,” the elements can be directly connected or coupled together or one or more intervening elements may also be present. In contrast, when elements are referred to as being “directly connected” or “directly coupled,” there are no intervening elements present.

The subject matter may be embodied as devices, systems, methods, and/or computer program products. Accordingly, some or all of the subject matter may be embodied in hardware and/or in software (including firmware, resident software, micro-code, state machines, gate arrays, etc.) Furthermore, the subject matter may take the form of a computer program product on a computer-usable or computer-readable storage medium having computer-usable or computer-readable program code embodied in the medium for use by or in connection with an instruction execution system. In the context of this document, a computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. By way of example, and not limitation, computer readable media may comprise computer storage media and communication media.

Computer storage media includes volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can accessed by an instruction execution system. Note that the computer-usable or computer-readable medium could be paper or another suitable medium upon which the program is printed, as the program can be electronically captured, via, for instance, optical scanning of the paper or other medium, then compiled, interpreted, of otherwise processed in a suitable manner, if necessary, and then stored in a computer memory.

Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer readable media.

When the subject matter is embodied in the general context of computer-executable instructions, the embodiment may comprise program modules, executed by one or more systems, computers, or other devices. Generally, program modules include routines, programs, objects, components, data structures, etc. that perform particular tasks or implement particular abstract data types. Typically, the functionality of the program modules may be combined or distributed as desired in various embodiments.

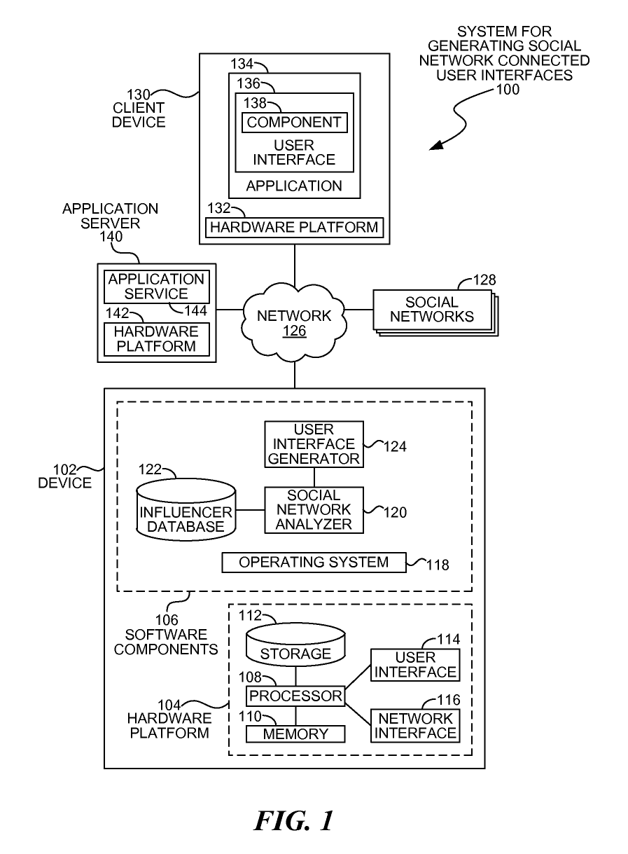

FIG. 1 is a diagram of an embodiment 100, showing an environment in which a system may generate user interfaces that incorporate information derived from social networks. Embodiment 100 is a simplified example of a network environment that may include a system that may generate user interfaces that are incorporated into other applications to present relevant data to a user based on the user's social networks.

The diagram of FIG. 1 illustrates functional components of a system. In some cases, the component may be a hardware component, a software component, or a combination of hardware and software. Some of the components may be application level software, while other components may be operating system level components. In some cases, the connection of one component to another may be a close connection where two or more components are operating on a single hardware platform. In other cases, the connections may be made over network connections spanning long distances. Each embodiment may use different hardware, software, and interconnection architectures to achieve the described functions.

Embodiment 100 is a simplified example of a network architecture in which a system may generate user interface components that contain information derived from a user's social network. A device 102 may receive information from an application from which various software components on the device 102 may generate a user interface component that may be transmitted to the application and displayed as part of the application.

Embodiment 100 is merely one example of an architecture that may be used to generate the user interface components. In some embodiments, the functions of device 102 may be incorporated into the application in which the user interface components may be presented.

The architecture of embodiment 100 may be useful in embodiments where social network information may be used in many different applications. For example, a retail shopping application may use the social network information to present a list of product reviews for a particular item on sale. In another example, a weblog may present comments on a posting that include information for the commenters, where the information is derived from the user's social network. In such a system, the social network information may be created and maintained in a central location, but used in many different applications.

The user interfaces may be arranged by and include social network information that may be based on people that are trusted by a user. Each user maintains one or more social networks either implicitly or explicitly. The implicit social networks may be lists of email or telephone contacts, while explicit social network may be formal social networks that may facilitate end-to-end communications.

The information derived from the social network may identify influencers within a user's social network. Influencers may be persons whose reputation and influence may be valued by the user. The influence may be based on the person's activities on the World Wide Web, various databases, as well as activities in various social networks. For example, a person who writes articles for weblogs or other publications, or a person who comments or participates in online discussions may be considered to have expertise in certain categories or contexts. Various metric may include the number of publications on the topic, the frequency of publication, the frequency of publication compared to other people in the same or different categories, or other metrics.

Other metrics may include the importance or influence of the person's publications. The metrics may include how many times the person's works are referenced, how many subscribers may receive the person's works, the number of page views for the person's works, feedback or comments regarding the person's works, or other types of metrics.

The person's publications may be publically available publications, such as weblog postings, comments, or participation in public forums. In some embodiments, the person's publications may be private or semi-private publications, such as email messages, instant messenger messages, message transmitted within the confines of a social network, or other such messages.

In some embodiments, a person may authorize or permit access for an evaluation system to determine the person's influence or reputation. In such embodiments, a person may sign up for an evaluation of the person's relative expertise in various categories, and the system may provide credentials, offers, or other items in exchange as an enticement for the analysis.

In systems that may access information that may be considered private to the person, the person may have to expressly authorize the system to access such information. Without such access, the system may be limited to analyzing publically available information to determine a person's reputation.

A person may also have influence through their social network activities. A person who is actively involved in social networking may have more influence than people who are not involved.

Various metrics from a social network may imply a person's reputation or influence. The sheer number of relationships may be a factor, and some embodiments may analyze the type or nature of the relationships. Such embodiments may identify relationships between experts in a field as an indicator that the person may also be an expert. Such embodiments may, for example, analyze the frequency that two people interact as an indicator of the strength of the relationship. In some embodiments, two people may enjoy multiple relationships through multiple channels. In such embodiments, the duplicative nature of the relationships may indicate a strong relationship.

For many applications, the actual propagation of a person's content or opinion through a chain of people may be a strong indicator of a person's influence. An example may be a success rate or conversion rate of a person's offers to other people, such as when the person offered a discount coupon or recommended a website, game, or other item to people in their social network. The conversion rate may strongly correlate to the person's influence.

In some instances, a person's comments or publications may start or may be part of a larger conversation across multiple weblogs, chat rooms, social networks, or other methods of communication. In such a case, the person's comments may be tracked or analyzed to determine what influence, if any, the person's comments had in the overall conversation. A person who produces commentary on a topic early and frequently in a long conversation may be considered to have a higher reputation and influence that someone who comments later in the conversation.

For each user, there may be a different set of people who are influential to the user. Those people may be identified from the user's social network from which a trust factor may be derived. The combination of a person's general influence coupled with the user's trust in the person may result in an influence factor from which the people in the social network may be ranked or arranged.

In some embodiments, a numerical score may be applied to a person's influence and a second numerical score may be applied to the user's trust factor. The two scores may be combined by multiplication or some other algorithm to determine the person's influence on the user.

The device 102 may have a set of hardware components 104 and software components 106. The client device 102 may represent any type of device that may communicate with an application.

The hardware components 104 may represent a typical architecture of a computing device, such as a desktop or server computer. In some embodiments, the client device 102 may be a personal computer, game console, network appliance, interactive kiosk, or other device. The client device 102 may also be a portable device, such as a laptop computer, netbook computer, personal digital assistant, mobile telephone, or other mobile device.

The hardware components 104 may include a processor 108, random access memory 110, and nonvolatile storage 112. The processor 108 may be a single microprocessor, multi-core processor, or a group of processors. The random access memory 110 may store executable code as well as data that may be immediately accessible to the processor 108, while the nonvolatile storage 112 may store executable code and data in a persistent state.

The hardware components 104 may also include one or more user interface devices 114 and network interfaces 116. The user interface devices 114 may include monitors, displays, keyboards, pointing devices, and any other type of user interface device. The network interfaces 116 may include hardwired and wireless interfaces through which the device 102 may communicate with other devices.

The software components 106 may include an operating system 118 on which various applications may execute.

A social network analyzer 120 may receive requests from various applications and search a user's social networks and an influencer database 122, then pass information to a user interface generator 124 that may generate a user interface component to be displayed as part of an application.

The social network analyzer 120 may generate different types of information based on the type of request supplied by an application. In some cases, the social network analyzer 120 may generate a ranked list of influencers for a specific user. In other cases, the social network analyzer 120 may gather information for one or more people and show the person's relationships to the user.

The user interface generator 124 may create information that may be consumed by an application and displayed for a user. In some embodiments, the user interface generator 124 may create display-ready data that may be passed to a browser or other mechanism to generate a user interface directly onto a user's monitor or other display. In one such embodiment, the user interface generator 124 may create user interfaces defined in Hyper Text Markup Language (HTML). Such user interfaces may be HTML documents that may be displayed in their entirety, or may be HTML snippets that may be incorporated into other HTML documents. Other embodiments may use other user interface definitions.

In some embodiments, a three tiered web architecture may be used. In a first tier, a web browser or other application may execute on a client device. A second tier may be a third party application that receives HTML requests from the browser and presents information in the browser. Also in the second tier, a server may generate a user interface component that may be displayed within the browser. A third tier may include several back end services, such as an influencer database, crawlers, or other components that may be used to generate the user interface components. Other embodiments may use different architectures.

The social network analyzer 120 may communicate over a network 126 to analyze various social networks 128. The social networks 128 may be any type of social network, including formal and informal social networks that may have one-way or two-way relationships within the social network.

The user interface generator 124 may communicate over the network 126 to communicate with a client device 130. The client device 130 may be a device on which the user interface components may be displayed as part of an application.

The client device 130 may have a hardware platform 132, which may be similar to the hardware platform 104 with a processor, memory, storage, a user interface, and a network interface, among other components.

On the hardware platform 132, an application 134 may execute, and the application 134 may generate a user interface 136. One component 138 of the user interface 136 may be supplied in whole or in part by the user interface generator 124.

In some embodiments, the client device 130 may execute an application 134 that may act as a browser or display module for an application provided by an application server 140. The application server 140 may have a hardware platform 142 on which an application service 144 may execute. The application service 144 may transmit information to the client device application 134 to display.

One common usage of an application server 140 may be for the application service 144 to provide HTML documents that are displayed on the client device 130, which may execute a browser application 134. As part of the HTML document displayed on the browser application 134, a call may be made to the device 102 requesting a user interface component 138. The user interface component 138 may be transmitted to the client device 130 or to the application server 140, to be incorporated into the user interface 136.

In some embodiments, the user interface component 138 may be requested by a plug-in or other component in the application 134. In such an embodiment, the plug-in or other component may monitor the application 134 and identify items that may be related to a user's social network. The plug-in may send a request to the social network analyzer 120 with the pertinent information and receive a user interface component that may be displayed next to, on top of, or nearby the user interface for the application 134.

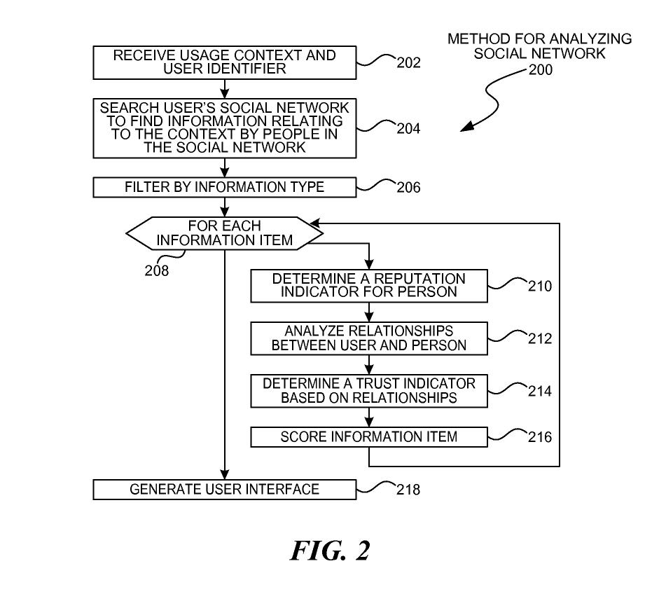

FIG. 2 is a flowchart illustration of an embodiment 200 showing a method for analyzing a social network. Embodiment 200 is a simplified example of a method that may be performed by a social network analyzer, such as the social network analyzer 120 of embodiment 100.

Other embodiments may use different sequencing, additional or fewer steps, and different nomenclature or terminology to accomplish similar functions. In some embodiments, various operations or set of operations may be performed in parallel with other operations, either in a synchronous or asynchronous manner. The steps selected here were chosen to illustrate some principles of operations in a simplified form.

Embodiment 200 is an example process that may be used to generate social network related information that may be presented in various user interface components. The method of embodiment 200 may be used to gather information that is relevant to a particular user within a social network. The information may be filtered and ranked according to people within the user's social network and organized so that information according the amount of trust the user may be likely to have in the information.

The system may receive a request that may include a usage context and user identifier in block 202. The usage context may identify the type of information requested, but also may identify the category or topic for the information. The type of information may be, for example, reviews of an item for purchase. The category may be, for example, a specific digital camera that may be offered for sale. In such an embodiment, the user interface component may include reviews of the particular camera that are filtered by the people within the user's social network and ranked by the trust that the user may have in the people who created the reviews.

In another example, the type of information may be a person's description and the category may be politics. The requesting application may be, for example, a political weblog for which the given person has created a posting, made a comment, or has been mentioned. The user interface component may include the person's relationship to the user and any factors that may indicate that the user has some trust in the person.

After receiving the request in block 202, the user's social networks may be searched to identify information relating to the usage context in block 204.

The search of block 204 may be performed in different manners in different embodiments. In one embodiment, the search may attempt to locate specific content within the social networks. For example, the search may attempt to locate product reviews for cameras. Such searches may work well for social networks that may support keyword or topical searches. Some formal networks may have a search feature that the system may attempt to use for such a search.

In another embodiment, the search may use a preexisting database of people, such as the influencer database 122 of embodiment 100, to identify people within the user's social network have influence in the specific topic. In such a search, the set of people in a user's social network may be identified and that set of people may be searched within the influencer database to identify a set of people who are influencers in the given category. Once the people are identified, those people may be searched to identify information items or content.

The information items or content that may result from the search may be defined in the request either by specific items or by a general category. A request that contains specific items may define product reviews, weblog postings or comments, social network postings, email or instant messages, or any other type of item that may be found through a computerized search. A request that contains a general category may identify a topic, such as photography, politics, or other category for which a user may have interest.

In some embodiments, the search results may be filtered by information type in block 206. The filter of block 206 may include or exclude certain types of information, such as weblog comments or product reviews.

Each information item may be analyzed in block 208. For each information item in block 208, a reputation indicator may be determined in block 210 for the person associated with the information item.

The reputation indicator may be a generalized indication of the person's expertise or general influence, but the reputation indication may not reflect the user's trust in the person. A high reputation may be derived from a person's expertise in the topic, the extent of that person's social network, the person's involvement or activity within the social network on the topic, or other factors.

In block 212, relationships between the user and the person are analyzed. In some cases, there may be multiple relationships between a user and the person. For example, the user may have the person in a contacts database, subscribe to the person's syndicated weblog publishing feed, follow the person on a one-way relationship formal social network, and have a two-way relationship established in another formal social network. The multiple relationships may indicate a much stronger and therefore more trusted relationship than an instance where a single relationship may exist.

In some embodiments, a system may be able to determine the strength of a relationship by analyzing the frequency or content of communications across the relationship. Some social networks may have some or all of the content publically accessible while other social networks, including informal social networks, may have such information as private. In such cases, permission may be received prior to accessing such information.

A trust indicator may be generated in block 214 based on the analysis of block 212. The trust indicator may be a numerical score or some other kind of indicator that may be combined with the reputation score to generate a score for the information item in block 216.

After identifying the information items and generating a score, a user interface may be generated in block 218.

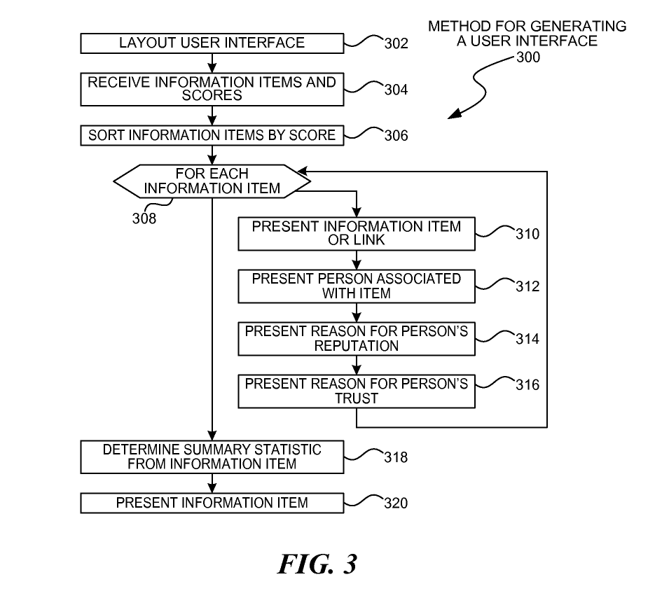

FIG. 3 is a flowchart illustration of an embodiment 300 showing a method for generating a user interface. Embodiment 300 is a simplified example of a method that may be performed by a user interface generator, such as the user interface generator 124 of embodiment 100.

Other embodiments may use different sequencing, additional or fewer steps, and different nomenclature or terminology to accomplish similar functions. In some embodiments, various operations or set of operations may be performed in parallel with other operations, either in a synchronous or asynchronous manner. The steps selected here were chosen to illustrate some principles of operations in a simplified form.

Embodiment 300 represents a general method by which a user interface may be generated using the information items that may be identified and scored in embodiment 200. Example user interfaces that may be produced using the method of embodiment 300 are presented later in this specification as embodiments 400 and 500.

In block 302, the user interface may be laid out. The layout process may define the outer boundaries of the user interface and the positioning of the various components. The layout process may define how certain items may look, including fonts, colors, shapes, and other features, as well as the general positioning of the items. In some embodiments, the layout step may be performed at the end of the method or at various points during the method.

In block 304, information items and scores for the information items may be received. The information items and scores may be those defined in embodiment 200 or a similar process.

Each of the information items may be sorted by score in block 306 and analyzed in block 308.

For each information item in block 308, the information item or link may be added to the user interface in block 310. The person associated with the information item may be added in block 312. The information relating to the person may have been retrieved from one or more social networks and may include a picture, name, company, title, or other relevant information.

The scoring for the information item may be based at least in part on the person's reputation. In block 314, a reason for the reputation score may be presented in the user interface. The reason may be one or more links to weblog postings, comments, or other items considered when creating the reputation score. In some cases, the reason may be a statistic about the person's social network, such as the number of followers or the frequency the person uses the social network. The reason may be presented as a displayed item, such as a text descriptor that shows the number of followers, for example, or the reason may include a link that may direct the user to the social network site where the number of followers was obtained.

A reason for the user's trust in the person may be presented in block 316. The user's trust may be derived from the user's social network and may include interactions between the user and the person. The reason for the user's trust may be presented as a statistic, link, or other mechanism. The reason for the user's trust in block 316 and the reason for the person's reputation in block 314 may help the user evaluate the person's credibility.

In some embodiments, various components of the user interface may be hidden from the user in various views. For example, a first view of the user interface may show merely a picture of the person but may not include the reasons for the person's reputation or the user's trust. However, an interactive link may toggle such reasons to be displayed, for example, so that the user may interact with the links associated with the various reasons.

In block 318, a summary statistic may be generated for the user. The summary statistic may consolidate some or all of the information items into a single statistic. For example, when the information items are product reviews taken from the user's social network, the summary statistic may be an aggregated score for the product being reviewed.

In some embodiments, the summary statistic may be an average value of all of the information items. In other embodiments, the summary statistic may be a weighted average value that may be weighted by the trust factor the user places in the person associated with the information item.

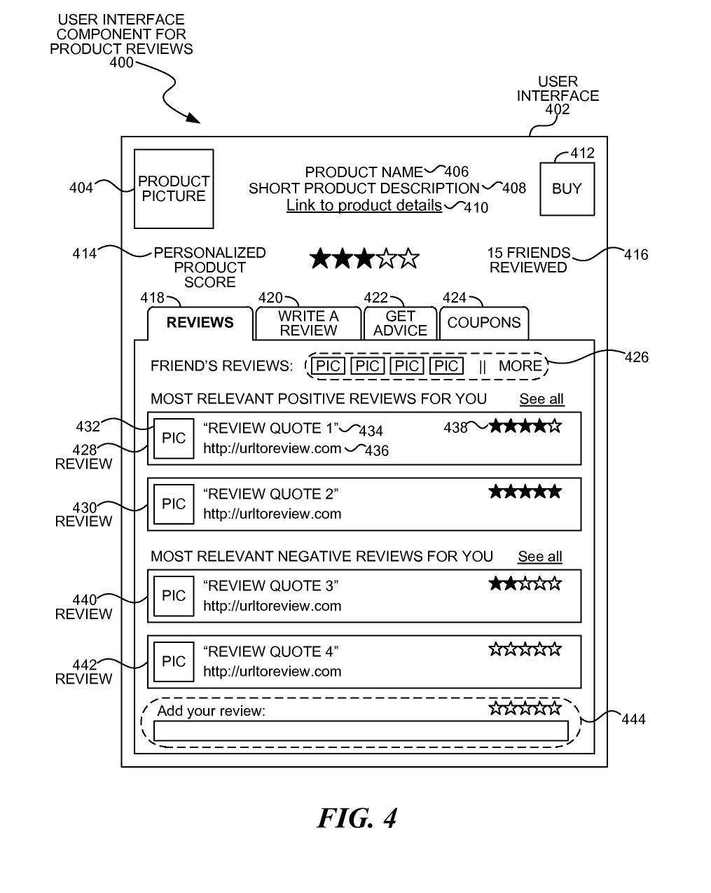

FIG. 4 is a diagram illustration of an embodiment 400 showing an example user interface that may be generated using the methods of embodiments 200 and 300. Embodiment 400 is merely one example of a user interface component that may include information derived from a user's social network that may take into account the influence of various people within the user's social network.

Embodiment 400 may be an example of a user interface component that includes product reviews for a specific product. The user interface component may be generated from a request that contains the product identifier and a user identifier. The request may also include various parameters and descriptors that may define the type of user interface component desired, along with any options that may be specified for the user interface component.

The user interface 402 may be presented to a user and may be customized for that particular user. The user interface 402 may include a description of a product offered for sale, along with a set of reviews. The reviews may be selected from the user's formal and informal social networks and specifically from people within the user's social network. The reviews may be ranked and presented with the most influential person's reviews highlighted.

The influential reviews may be dependent on the person's reputation but also the user's trust in the person. The user's trust may be derived from the user's social network, which may cause each instance of the user interface 402 to be different for each user.

The user interface 402 may include a product picture 404, product name 406, short product description 408, and a link to product details 410. The user interface 402 may also include a button 412 through which the user may purchase the item.

The user interface 402 may include a personalized product score 414, which may include a basis 416 for the product score, as illustrated by the number of friends that reviewed the product.

The personalized product score 414 may represent an aggregated score of the product reviews, where the product reviews were taken from the user's social network. In some cases, the aggregated score may be determined solely from information gathered within the user's social network. Such information may be aggregated using averaging, weighted averaging, or other algorithms that may or may not take into account a trust factor for the user.

The personalized product score 414 operates as a summary statistic for the information collected. The basis 416 for the information may provide the user with a scope of the information gathered and may reflect how much weight the user may place in the summary statistic. In the example of embodiment 400, a personalized product score that was based on one or two people's evaluations may be less significant than a personalized product score that was based on several hundred people's evaluations.

The user interface 402 may include several tabbed sections. The tabbed sections may be a mechanism to hide or display various subgroups of information in the user interface through interactive components. Each tab may present a different subgroup of information in the pane of the user interface below the tab. In some embodiments, each tab may be an interactive component that a user may select to update the user interface.

The various tabs in the user interface 402 include a review tab 418, a write a review tab 420, get advice tab 422, and a coupons tab 424. The review tab 418 is illustrated as being selected and contains various reviews about the product. The reviews may have been selected from the user's social network an arranged in accordance with the user's trust in the reviewer combined with the reviewer's reputation. Embodiment 400 illustrates an example where the reviews are further grouped according to positive and negative reviews.

The group 426 may illustrate various friends of the user who have reviewed the product. The pictures in the group 426 may be pictures of the people in the user's social network. In some embodiments, a user may place a cursor or pointing device over the people's pictures to bring up a popup window that shows the person's reviews, contact information, or other information.

In some embodiments, a person's reputation may be displayed in the form of badges or other certifications. For example, a person may be a certified professional with credentials in a specific field. In another example, a person may have a reputation in a specific topic, such as photography or baseball that a reputation engine or other service may grant the person a bronze, silver, or gold badge as having various levels of reputation in the field.

The reviews 428 and 430 are organized into a group that includes the most relevant positive reviews for the user. The reviews 428 and 430 may be selected and sorted based at least in part on the user's trust in the people who generated the reviews. Similarly, the reviews 440 and 442 may be a group that includes the most relevant negative reviews for the user.

The relevance of the reviews to the user may be based on the reputation of the person who wrote the reviews, combined with the user's trust in the individual people, as well as the context in which the product belongs. For each user, the reviews selected for the user interface 402 may be different.

The review 428 may include components that are common to all of the reviews. The components may include a picture 432 of the person who wrote the review, a summary quote 434, a link to the source of the quote 436, and a graphical indicator 438 of the person's review.

User interface 402 may include a section 444 through which the user may add their own review of the product. In some embodiments, the user may be able to attach a coupon or other traceable object to a review. The section 444 may be an input component that may receive information within the user interface. The information may be transmitted to a social network, retail site, or other system to be stored and associated with the user.

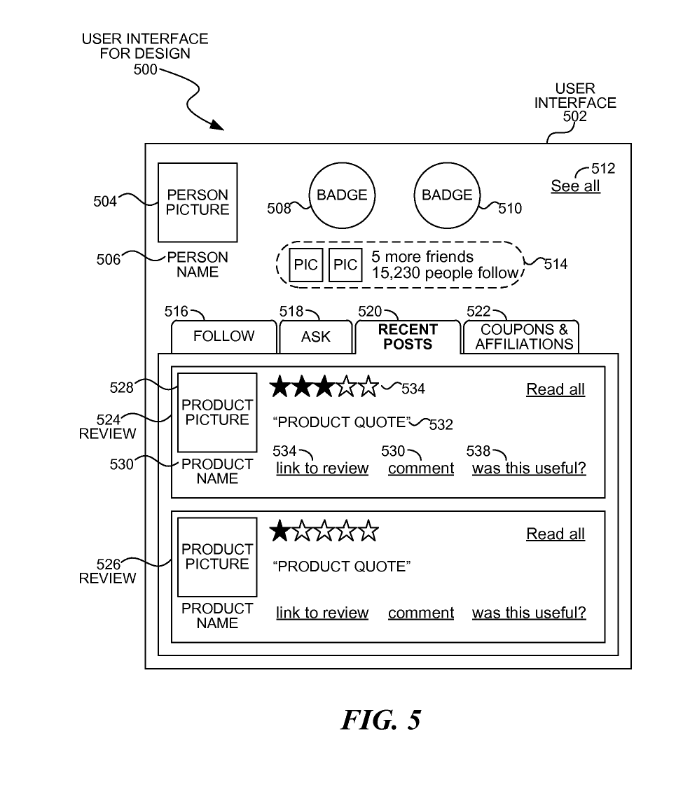

FIG. 5 is a diagram illustration of an embodiment 500 showing an example user interface that may be generated using the methods of embodiments 200 and 300. Embodiment 500 is merely a second example of a user interface component that may include information derived from a user's social network that may take into account the influence of a person within the user's social network.

Embodiment 500 may be an example of a user interface component that includes information about a person within a user's social network. The information presented may include information that is customized based on the user's social network and the level of trust that the user may have in the person whose information is being displayed.

The user interface 502 may be an example of a user interface that shows pertinent or relevant information about a person in a user's social network. The user interface 502 may be presented within an application that may reference the person. For example, a user may browse to a weblog that may contain posts and comments created by people in the user's social network. Within the weblog application, the user interface 502 may be presented to help the user identify and research the people who have participated in the weblog.

The user interface 502 may include a picture 504 of the person, along with the person's name 506. Various credentials may be presented in the form of badges 508 and 510, as well as a link 512 to see additional credentials. In some embodiments, different badges may be presented in different information contexts. The group 514 may include pictures of people that are common between the person's social network and that of the user. The group 514 may include other credentials or reasons why the person has their current reputation and/or trust ratings.

The user interface 502 may include several tabs which may present subgroups of information relevant to the user. The tab 516 may allow the user to establish one or more social network connections to the person. Tab 518 may enable the user to communicate with the person through one or more social networks. Tab 520, which is shown as displayed, includes recent posts or other actions performed by the person. In some embodiments, the person's actions relating to coupons or other social marketing objects may be presented. Tab 522 may include various social marketing system coupons or affiliations.

In some embodiments, the user interface 502 may include components that show a person's affiliations. The affiliations may be contractual, financial, or other arrangements by which a person may be promoting a certain product or line of products. In such embodiments, a user may be able to view the affiliations and may a judgment of how much to trust or distrust a person.

Within the recent posts tab 520, two product reviews are illustrated. The product reviews 524 and 526 may be filtered to be relevant to the context in which the user interface is being used. When the user interface is requested, the request may include a context in which the user interface may be used. The context may define a category, topic, or other usage. The context may be, for example, photography and therefore the user interface 502 may include reviews relevant to photography. In some embodiments, the user interface 502 may include any review or any activity by the person, regardless of context.

The reviews 524 and 526 may be merely one example of user created information that may be retrieved from a social network or other source. In the example of embodiment 500, the user created information may be created by the person 502.

The reviews 524 and 526 may include similar components, such as a product picture 528 and product name 530, as well as a short quote 532, a review summary 534, and a link to the review 536. The reviews may also include some user interface components for capturing information about the reviews, including a comment input 536 and a “was this useful” input 538.

The example user interfaces 402 and 502 are merely two examples of the user interfaces that may include information derived from and customized based on a user's social network. Other embodiments may contain different information, which may be arranged in different formats.

The foregoing description of the subject matter has been presented for purposes of illustration and description. It is not intended to be exhaustive or to limit the subject matter to the precise form disclosed, and other modifications and variations may be possible in light of the above teachings. The embodiment was chosen and described in order to best explain the principles of the invention and its practical application to thereby enable others skilled in the art to best utilize the invention in various embodiments and various modifications as are suited to the particular use contemplated. It is intended that the appended claims be construed to include other alternative embodiments except insofar as limited by the prior art.

What is claimed is:

1. A method performed on at least one computer processor, said method comprising:
receiving a user identifier and a context, said user identifier identifying a user;
identifying a plurality of user created information, each of said plurality of user created information being associated with at least one person having a relationship with said user in a social network;
for each of said created information, determining a trust factor between said user and said at least one person based on said user's relationships within said online social network;
determining a ranking for said user created information based at least in part on said trust factor; and
presenting said user created information according to said ranking on a user interface.

2. The method of claim 1, said relationship comprising at least a two degree relationship to said user.

3. The method of claim 1, said context being a node in a hierarchical taxonomy of topic classifications.

4. The method of claim 1, said user interface being a user interface component within an application user interface.

5. The method of claim 4, said application user interface being provided by an application server and said user interface being supplied by a social marketing server.

6. The method of claim 5, said application server transmitting said user identifier and said context.

7. The method of claim 1, said trust factor being determined at least in part by determining a number of nodes between said user and said person in a social network.

8. The method of claim 7, said number of nodes being determined from a plurality of social networks.

9. The method of claim 1 further comprising:
presenting at least one indicator used to determine said trust factor in said user interface.

10. A user interface presented on a computer device as part of an application, said application having a usage context and being executed for a user, said user interface comprising:
a person identifier for a person being within a computerized social network and related to said user;
a reputation indicator that indicates a reputation level for said person;
at least one trust descriptor that indicates a trust type between said user and said person; and
a link to a document being a document from which said reputation level was at least partially derived.

11. The user interface of claim 10 further comprising:
an input mechanism that launches a communication mechanism to communicate with said person.

12. The user interface of claim 11, said communication mechanism being a communication mechanism available within said computerized social network.

13. The user interface of claim 11, said communication mechanism being a communication mechanism operating outside said computerized social network.

14. The user interface of claim 10 further comprising:
a plurality of expertise indicators, each of said expertise indicators having a usage context indicator.

15. The user interface of claim 10 further comprising:
a link to a document relating to said usage context and associated with said person.

16. The user interface of claim 15, said document comprising a product review for a product relating to said usage context.

17. A user interface presented on a computer device as part of an application, said application having a usage context and being executed for a user, said usage context comprising a product, said user interface comprising:
a plurality of reviews for said product, said reviews being reviews created by people within a social network for said user;
for each of said reviews:
a person identifier for a person being within a computerized social network and related to said user;
an reputation indicator that indicates an expertise level for said person;
at least one trust descriptor that indicates a trust type between said user and said person; and
a link to a document being a document from which said expertise level was at least partially derived.

18. The user interface of claim 17, said plurality of reviews being sorted by a trust factor derived from said social network.

19. The user interface of claim 18, said plurality of reviews being further grouped by positive and negative reviews.

20. The user interface of claim 19 further comprising at least one picture for one of said persons.
